(19) United States
(12) Patent Application Publication
(10) Pub. No.: US 2026/0088191 A1
(43) Pub. Date: Mar. 26, 2026

(54) SYSTEM FOR THE TRANSFER AND STORAGE OF RADIOACTIVE WASTE FOR A SHIELDED CELL

(71) Applicant: COMECER S.P.A., Castel Bolognese (RA) (IT)

(72) Inventors: Alberto Lega, Castel Bolognese (RA) (IT); Alessandro Brunetti, Castel Bolognese (RA) (IT); Marco Testa, Castel Bolognese (RA) (IT); Filippo Galassi, Castel Bolognese (RA) (IT)

(21) Appl. No.: 19/113,661

(22) PCT Filed: Sep. 28, 2023
(86) PCT No.: PCT/IB2023/059688

§ 371 Date: Mar. 20, 2025

(30) Foreign Application Priority Data
Sep. 30, 2022 (IT) 102022000020205

(51) Int. Cl. G21F 7/005; G21F 5/005; G21F 5/12; G21F 5/14; G21F 7/06

(52) U.S. Cl. CPC G21F 7/005; G21F 5/005; G21F 5/12; G21F 5/14; G21F 7/061

(57) ABSTRACT

A system for transferring and storing radioactive waste for a shielded cell comprising a duct for discharging radioactive waste, the system having: a first frame which is attachable below the duct; a cylindrical shielded container for radioactive waste, provided with a collar; a rapid transfer port having an alpha port fixable on the duct and a beta port closing the container; a second frame to support the container through the collar, and movable relative to the first frame towards an alignment position, wherein the container is coaxial to the discharge duct; a shielded cover movably mounted on the collar to cover and uncover the beta port; a lifter to lift the container to a raised position, wherein the beta port rests on the alpha port; and a rotating key mounted on the first frame to rotate coaxially to the duct, engageable by an outer portion of the container in the raised position to allow coupling between the beta port and the alpha port.

### CROSS-REFERENCE TO RELATED APPLICATIONS

This Patent Application claims priority from Italian Patent Application No. 102022000020205 filed on Sep. 30, 2022, the entire disclosure of which is incorporated herein by reference.

### TECHNICAL FIELD

The present invention relates to a system for the transfer and storing of radioactive waste.

In particular, the present invention is advantageously, but not exclusively, applied to the production of (solid or liquid) radioisotopes within a shielded cell, to which the following description will make explicit reference without losing generality.

### BACKGROUND

Radioisotope production typically comprises a number of steps performed within a shielded cell, and in particular a pharmaceutical isolator shielded against the transmission of ionising radiation, also known as a hot cell. These steps involve the production of solid radioactive waste, such as small tubes, disposable kits, vials and process waste materials, which have to be removed from the shielded cell.

Normally, the shielded cell is provided with a shielded waste compartment which is accessible from inside the shielded cell through a hatch, houses a metal or plastic primary container and is not normally air-tightly sealed relative to the outside. The operator handles the radioactive materials within the shielded cell by means of flange gloves and releases the solid radioactive waste into the primary container by hand, or by remotely operated handling devices.

When the primary container is full, it has to be transferred to a technical area or laboratory area. However, before the primary container can be removed from the waste compartment, the solid radioactive waste contained therein must decay, i.e. exhaust the radioactivity thereof, so that the operator can manually close the primary container by means of a cap or cover with a low risk of radiation exposure.

The decay time greatly depends on the pharmaceutical radioisotope produced and can be up to several days. Therefore, in order to guarantee a minimum level of safety for the operator, it is necessary to stop the production of the radioisotope even for several hours. Moreover, the inside of the primary container, which is contaminated by solid radioactive waste and is not air-tightly sealed, is exposed to the external environment and thus exposes the operator to non-negligible radiation doses, especially if repeated over time during normal working activity.

### SUMMARY

The aim of the present invention is to implement a system for the transfer and storing of solid radioactive waste for a shielded cell wherein radioisotopes for pharmaceutical use are produced, which system is free of the drawbacks described above and, at the same time, is easy and cheap to implement.

According to the present invention, a system is provided for the transfer and storing of radioactive waste as defined in the appended claims.

### BRIEF DESCRIPTION OF THE DRAWINGS

The present invention will now be described with reference to the attached drawings, which show a non-limiting embodiment thereof, wherein:

FIGS. 1 and 2 show, from two respective perspective views from two different vantage points, the system for the transfer and storing of radioactive waste according to the present invention in an operating step;

FIG. 3 is a vertical longitudinal section view of the system in the operating step of FIGS. 1 and 2;

FIG. 4 shows, in a partially exploded perspective view, a shielded container of the system of the invention and a part of the system of the invention supporting the shielded container;

FIGS. 5 and 6 show, in a same perspective view from below, the system of the invention in two subsequent operating steps;

FIG. 7 shows the vertical longitudinal section view of the system in the operating step of FIG. 6;

FIGS. 8A-8E show, in a plan view, kinematic coupling means between movable parts of the system of the invention during subsequent moments of the passage from the operating step of FIG. 5 to the operating step of FIG. 6; and

FIG. 9 shows, in a vertical longitudinal section view, the system of the invention in a further operating step subsequent to that shown in FIG. 6.

### DESCRIPTION OF EMBODIMENTS

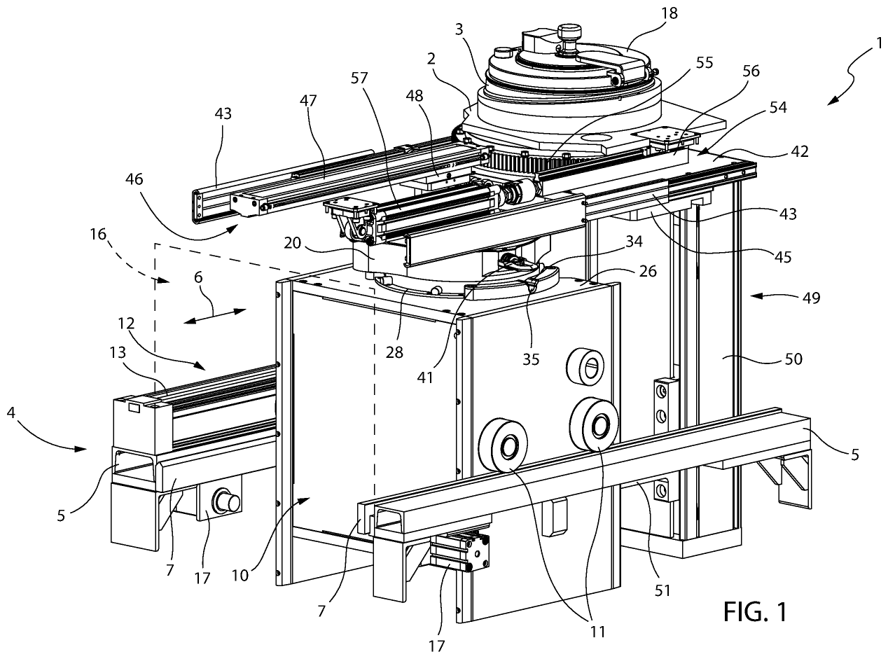

In FIGS. 1 to 3, 1 generically denotes the system of the present invention for the transfer and storing of radioactive waste for a shielded cell (not shown as a whole), e.g. an isolator for the production of radio-pharmaceuticals, comprising a work surface 2 having a discharge duct 3 for allowing discharge of radioactive waste from inside the shielded cell. As it is a shielded cell, the work surface 2 and the discharge duct 3 are either coated with, or incorporate a layer of material shielding against ionising radiation.

The system 1 comprises a housing frame 4, which is attachable to the shielded cell below the work surface 2. The housing frame 4 comprises shielded closing panels, which are not shown in the Figures to show the most significant inner parts of the system 1. The housing frame 4 comprises a pair of struts 5, which extend parallel to a substantially horizontal direction 6, and at least one guide, and in particular two guides 7, each of which is attached to a respective strut 5 so as to be parallel to the direction 6.

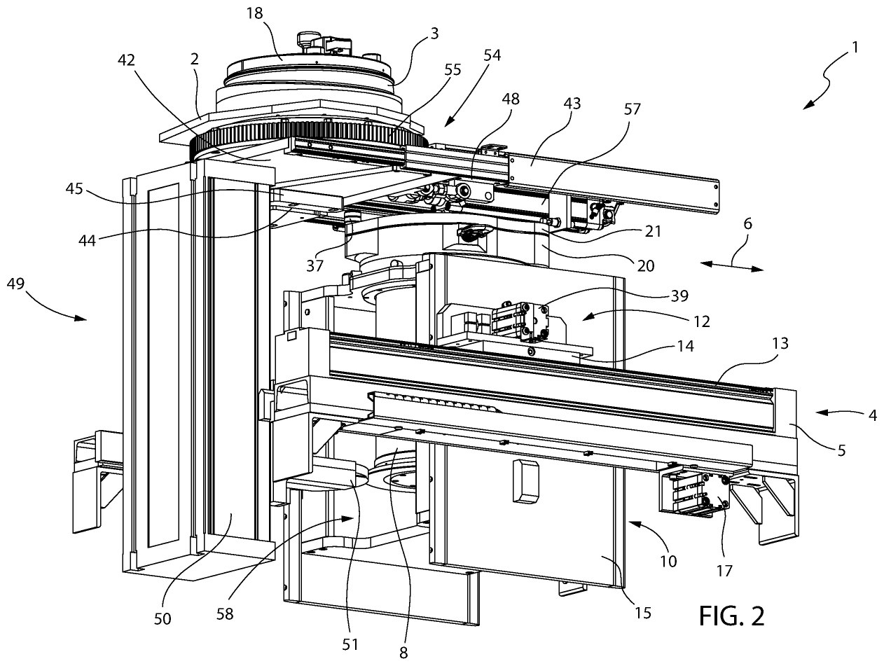

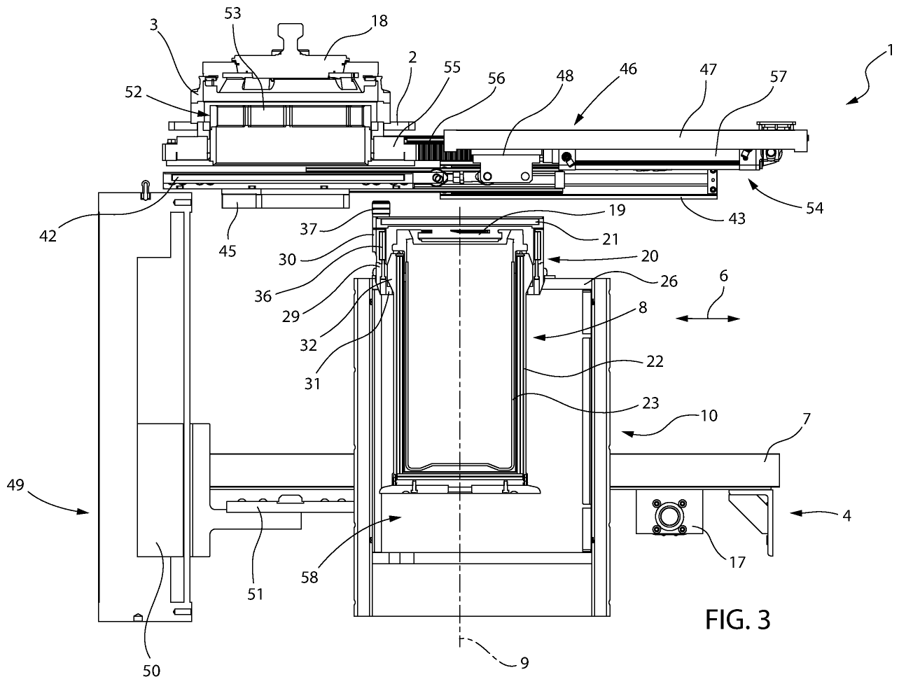

The system 1 comprises a shielded container 8 (FIGS. 2 and 3) with a cylindrical shape extending along an axis 9 (FIG. 3) to contain the radioactive waste, and a support frame 10, which is made, for example, in the form of a trolley, supports the shielded container 8 with the axis 9 transversal, and in particular perpendicular, to the direction 6 and is movable with respect to the housing frame 4 forward and backward in the direction 6. In particular, the support frame 10 slides along the guides 7. In particular, the support frame 10 is provided with two pairs of wheels 11 for sliding along the guides 7.

With particular reference to FIG. 2, the system 1 comprises a linear actuating device 12 having a guide 13 attached to a strut 5 and a motorised slide 14, which is suitable for moving along the guide 14 and is couplable to a side wall 15 of the support frame 10 to move the latter forward and backward with respect to the direction 6.

The housing frame 4 comprises a front opening 16, the edge of which is drawn with a dotted line in FIG. 1, for manually loading the support frame 10 onto the guides 7. The opening 16 is closed by a shielded port, not shown. The system 1 comprises two electrically actuatable safety devices 17 to prevent the support frame 10 from exiting the guides 7 in the exit direction from the opening 16 once the support frame 10 has been loaded.

Referring in particular to FIG. 3, the system 1 comprises a rapid transfer port of a known type, and in particular normally referred to by the acronym RTP, which has an alpha port 18 fixable to the discharge duct 3 coaxially thereto and which is openable form inside the shielded cell, and a beta port 19 which closes the shielded container 8.

The shielded container 8 has a collar 20 and the support frame 10 supports the container 8 by means of the collar 20. The shielded container 8 is also provided with a shielded cover 21, which is mounted on the collar 20 in a movable manner between a covered position, in which the shielded cover 21 covers the beta port 19, as shown in FIGS. 1 to 3, and an uncovered position, in which the shielded cover 21 is out of the way and allows the shielded container 21 to be lifted from the collar 20.

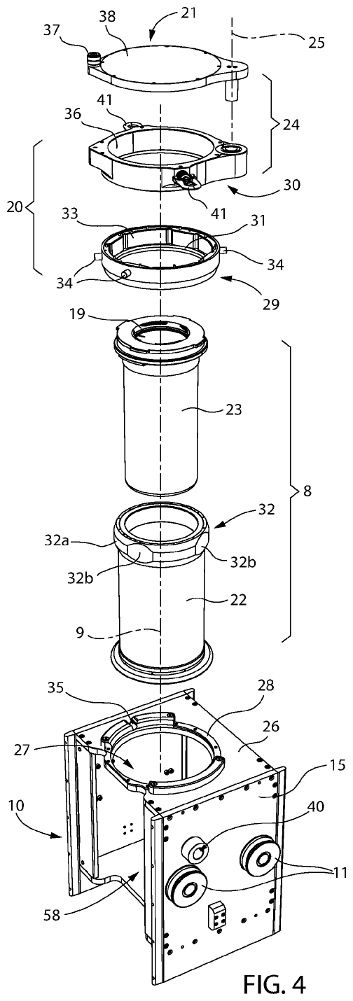

Referring to FIGS. 3 and 4, the shielded container 8 comprises an outer container 22, which is open at the top and is entirely shielded against ionising radiation by at least one layer of shielding material, and an inner container 23, to which the beta port 19 is connected and which is housed inside the outer container 22 with the beta port 19 protruding to the outside to allow coupling with the alpha port 18. The shielded cover 21 is mounted on the collar 20 by means of a hinge 24 so as to rotate about an axis 25 parallel to the axis 9 and outside the shielded container 8.

The support frame 10 comprises an upper panel 26, which has a hole 27, clearly visible in FIG. 4, for the passage of the shielded container 8, and a support portion 28, which surrounds the hole 27 and is for supporting the collar 20. The collar 20 comprises a lower annular portion 29, which rests on the support portion 28, and an upper annular portion 30, on which the shielded cover 21 is mounted.

The lower annular portion 29 partially engages the hole 27 and comprises an inner shoulder 31 and the container comprises an outer portion 32, which has the shape of an annular protrusion to rest on the inner shoulder 31 so that the shielded container 8 is supported by the collar 20.

The outer portion 32 has an annular surface 32a that is suitably shaped and the lower annular portion 29 comprises an annular element 33 that is internally engageable by the outer portion 32 with a shape coupling, i.e. the annular element 33 has an inner face that is shaped in such a way as to obtain a shape coupling with the annular surface 32a of the outer portion 32. In particular, the annular face 32a comprises a plurality of facets 32b, four in number, preferably parallel to the axis 9.

The lower annular portion 29 further comprises a plurality of radially protruding pivots 34 resting on the support portion 28. The support portion 28 comprises a cut 35 suitable to be engaged by one of the pivots 34 to centre the collar 20, as also shown in FIG. 1, and thus the entire shielded container 8, on the support portion 28 in such a way that the beta port 19 is positioned according to an appropriate angular displacement about the axis 9 with respect to the angular position of the alpha port 18 to allow the subsequent coupling thereof.

The upper annular portion 30 incorporates a cylindrical element 36 which is made of a material shielding against ionising radiation and which is arranged around the beta port 19 when the shielded container 8 is supported by the second frame 10, such as when the system 1 is in the operating step shown by FIGS. 1 to 3.

The shielded cover 21 comprises a pivot element 37, which is mounted on an upper face 38 of the shielded cover 21 and is parallel to the axis 9 to act as a crank with respect to the axis 25.

The actuating device 12 comprises a connecting device 39 mounted on the slide 13 (FIG. 2) and having a pivot (not visible) that can be controlled to be pulled out to engage a perforated element 40 (FIG. 4) of the side wall 15 of the support frame 10.

The collar 20 comprises a pair of handles 41 to allow an operator to insert and remove the shielded container 8 into and from the support frame 10

Referring again to FIGS. 1 to 3, the system 1 comprises a shielded shutter 42, which is mounted under the work surface 2 in a movable manner between a closed position, wherein the shielded shutter 42 covers the discharge duct 3, as shown in FIGS. 1 to 3, and an open position, wherein the shielded shutter 42 is out of the way of the discharge duct 3. In particular, the shielded shutter 42 moves forward and backward parallel to the direction 6, along an essentially horizontal plane. More specifically, the housing frame 4 comprises two telescopic guides 43 mounted below the work surface 2 and arranged parallel to the direction 6, and the shielded shutter 42 is attached to the movable end portions of the two telescopic guides 43.

The shielded shutter 42, on a lower, i.e. downward-facing faces thereof, is provided with a guide 44 (FIG. 2), which is engageable in a sliding manner by the pivot element 37 of the shielded cover 21 during the operation of the system 1. In particular, the guide 44 defines a path for the pivot element 37 parallel to the shielded shutter 42. More specifically, the guide 44 is defined by a groove obtained on a plate 45 that is fixed to the lower face of the shielded shutter 42. Advantageously, the pivot element 37 comprises a roller suitable to run along the guide 44 by rotating around its own axis.

The pivot element 37, the plate 45 and its guide 44 define kinematic coupling means of the system 1, which connect in a movable manner the shielded cover 21 to the shielded shutter 42 so that a movement of the shielded shutter 42 towards the open position produces a movement of the shielded cover 21 towards the uncovered position, as will be further explained below.

The system 1 comprises a linear actuating device 46 having a guide 47, which is fixed to the housing frame 4 between the two telescopic guides 43 so as to be parallel to the direction 6, and a slide 48, which is movable along the guide 47 and is connected to the shielded shutter 42.

The system 1 comprises a lifter 49 for moving the shielded container 21 parallel to the axis 9 towards and from a raised position, wherein the beta port 19 rests on the alpha port 18. In particular, the lifter 49 comprises a linear actuating device 50, which is arranged vertically between the ends of the two guides 7, and a platform 51, which is moved by the actuating device 50 to lift and lower the shielded container 8 by supporting it from its bottom.

The system 1 further comprises a rotating key 52 (FIG. 3), which is mounted on the housing frame 4 to rotate coaxially to the discharge duct 3 and is engageable by the outer portion 32 of the shielded container 8, when the latter is in the raised position, to allow, by rotation of a predetermined angle, the coupling in a known manner between the beta port 19 and the alpha port 18 and the opening of the rapid transfer port. In greater detail, the rotating key 52 comprises an annular element 53, which is arranged inside the discharge duct 3 coaxially thereto and is analogous to the annular element 33 of the collar 20 in that it is internally engageable by the outer portion 32. In other words, the annular element 53 has an inner face that is shaped to form a shape coupling with the annular surface 32a of the outer portion 32.

The system 1 comprises a further actuating device 54, which comprises a toothed wheel 55 integral with the annular element 53, a rack 56 engaged with the gear wheel 55 and a linear actuator 57 for moving the rack 56. In particular, the toothed wheel 55 is coaxial to discharge duct 3 and is fitted on the outside of the discharge duct 3.

In use, an operator inserts the shielded container 8 provided with the collar 20 into the support frame 10, supporting the shielded container 8 by the handles 41, and loads the support frame 10 onto the guides 7 through the opening 16 to a position that allows the support frame 10 to be coupled to the actuating device 12 by means of the connecting device 39 (FIG. 1). At this point, the operator provides a command to a control unit (not shown) of the system 1 which, by actuating the actuating devices 12, 46, 50 and 54 in an appropriate sequence, leads the shielded container 8 to connect with the discharge duct 3 and allows the opening of the rapid transfer port 18-19.

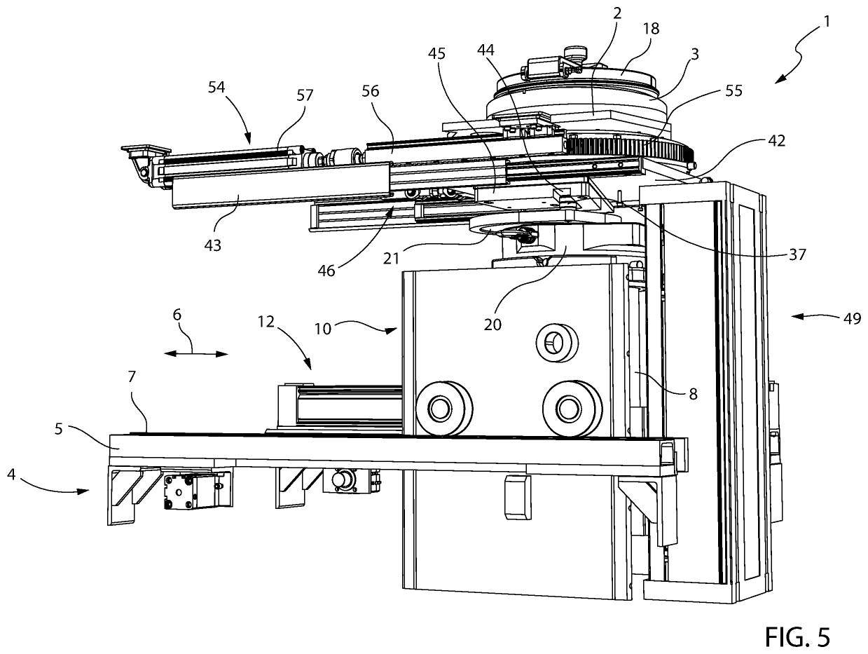

In particular, the aforementioned control unit is configured to control the actuating devices 12, 46, 50 and 54 in the order described below, with particular reference to FIGS. 5, 6, 7 and 9.

The actuating device 12 advances the support frame 10 in the direction 6 to an alignment position, which is shown by FIG. 5, wherein the shielded container 8 is coaxial to the discharge duct 3. During this movement, the pivot element 37 engages and slides along a section of the guide 44, causing partial rotation of the shielded cover 21 with respect to the covered position without, however, reaching the uncovered position, as can be seen in FIG. 5.

The attainment of the alignment position is detected, for example, by means of an end-of-stroke sensor, which is known in itself and not shown, mounted on the slide 14 of the actuating device 12.

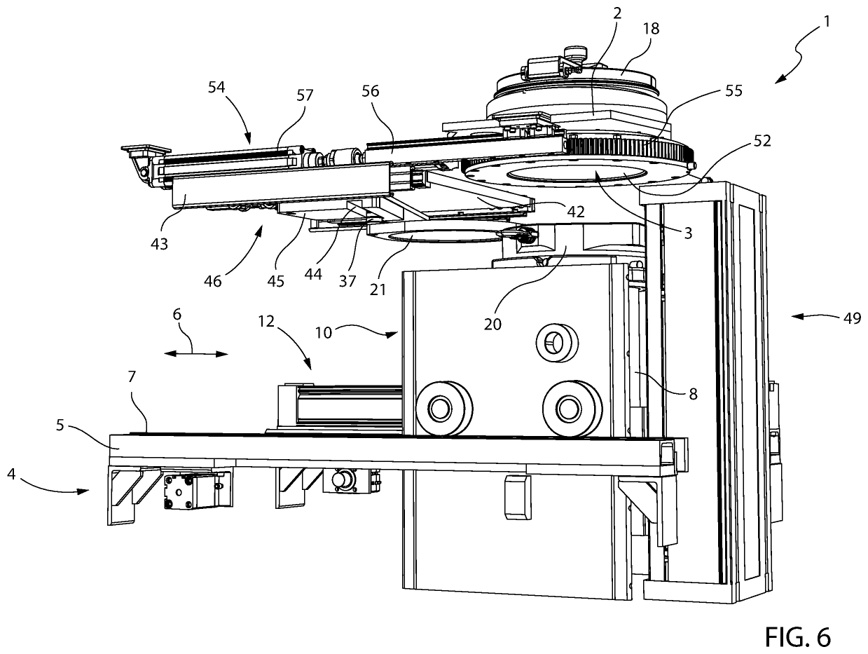

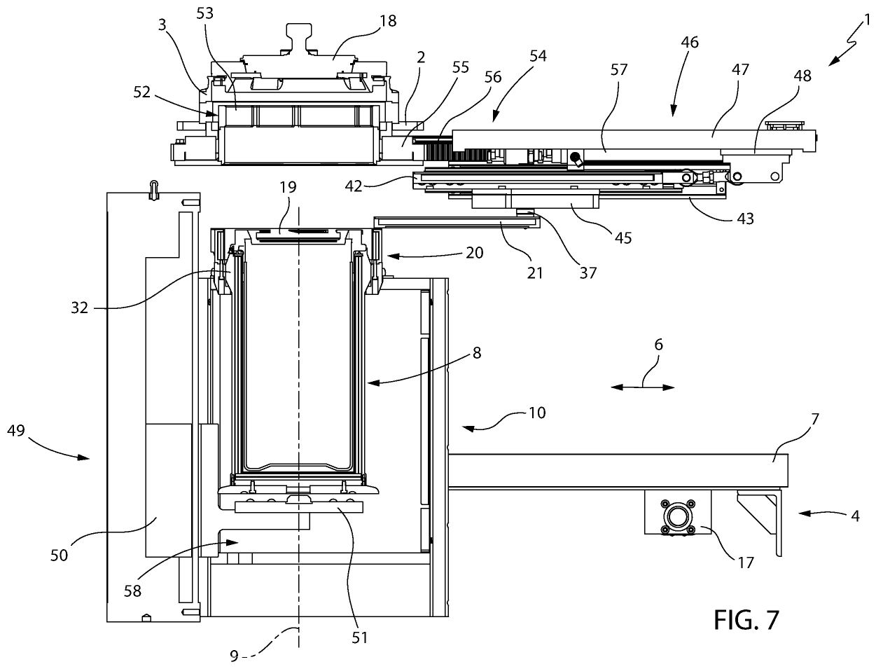

At this point, the actuating device 46 moves the shielded shutter 42 from the closed position to the open position, which is shown by FIGS. 6 and 7, where the shielded shutter 42 is out of the way with respect to the discharge duct 3. The movement of the shielded shutter 42 towards the open position produces a movement of the shielded cover 21 towards the uncovered position, also shown by FIGS. 6 and 7. As it can be seen in FIG. 7, in the alignment position, the shielded container 8 is coaxial to the discharge duct 3 and with its bottom placed above the platform 51, which passes through a rear opening 58 of the support frame 10. The rear opening 58 is also visible in FIGS. 2 and 4.

The attainment of the open and closed positions is detected, for example, by means of end-of-stroke sensors, which are known and not shown, fixed to the housing frame 4.

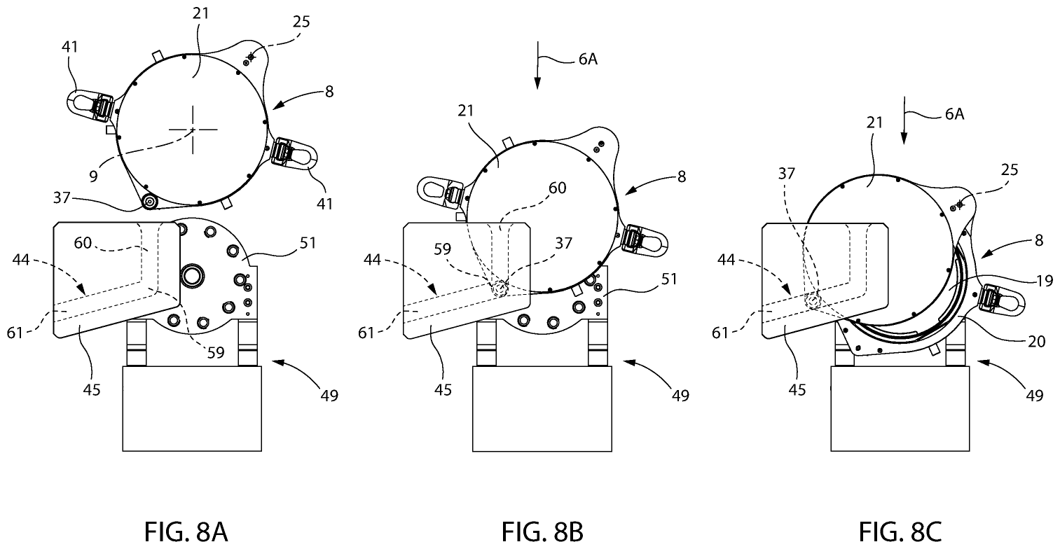

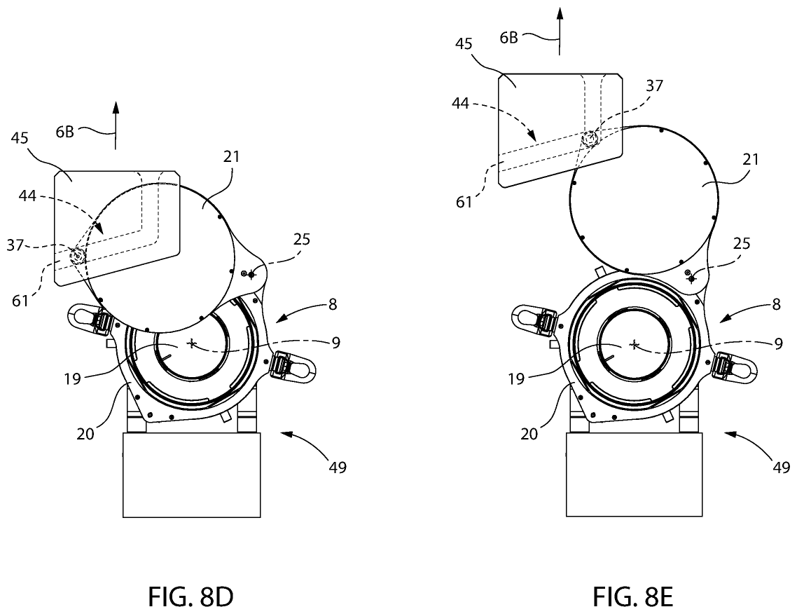

FIGS. 8A to 8E show the system 1 according to a plan view with many parts removed, at different moments of the movement of the support frame 10, and thus of the shielded container 8, in a direction 6A parallel to the direction 6 of the other figures, i.e. towards said alignment position and of the subsequent movement of the shielded shutter 42, and therefore of the plate 45 with the guide 44, in an opposite direction 6B, i.e. from said closed position to said open position, in order to explain the kinematic coupling between the pivot element 37 and the guide 44.

Referring to FIGS. 8A-8E, the guide 44 defines a path for the pivot element 37 which comprises at least one sharp turn 59. In particular, the guide 44 defines a substantially L-shaped path comprising a first straight section 60 parallel to the direction 6A and a second straight section 61 extending transversely to section 60 from the turn 59.

When the support frame 10, and thus the shielded container 8, moves in the direction 6A towards the alignment position, the pivot element 37 enters the section 60 of the guide 44 and runs through it to the turn 59 while the plate 45 is stationary (FIGS. 8A and 8B). The pivot element 37 reaches the turn 59 before the shielded container 8 reaches the alignment position (FIG. 8B). Thus, the pivot element 37 is forced into the section 61 while the shielded container 8 travels across the remaining journey to the alignment position, thus causing a partial rotation of the shielded cover 21 relative to the cover position (FIG. 8C).

The movement of the plate 45 in the direction 6B towards the open position, while the shielded container 8 is stationary in the alignment position, accompanies the pivot element 37 forward (FIG. 8D) and then backward (FIG. 8E) along the section 61 of the guide 44, thus causing the rotation of the shielded cover 21 to the uncovered position (FIG. 8E).

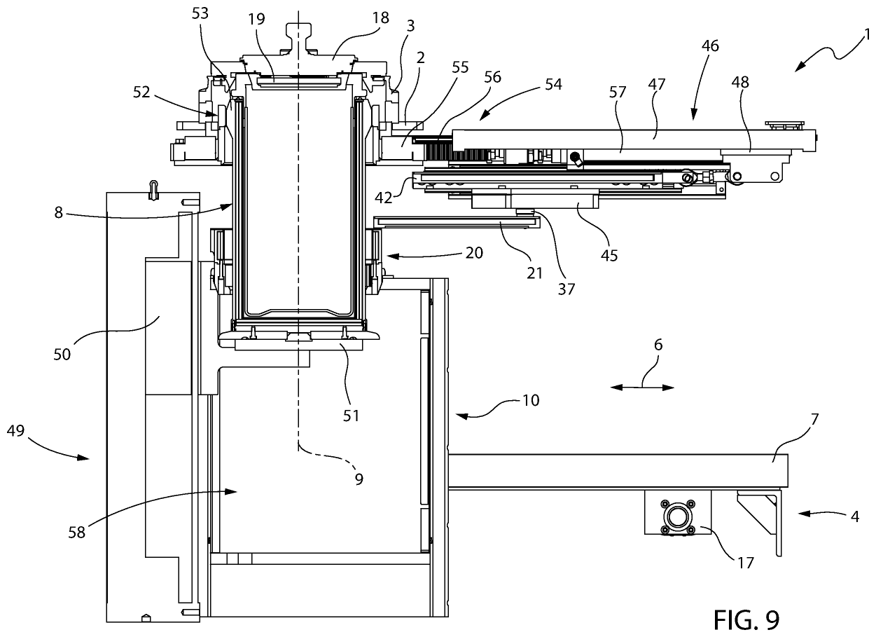

At this point, i.e. when the shielded container 8 is in the alignment position, the shielded shutter 42 is in the open position and the shielded cover 21 is in the uncovered position, the actuating device 50 moves the platform 51 parallel to the axis 9 to bring the shielded container 8 to a raised position, wherein the beta port 19 rests on the alpha port 18, as shown in FIG. 9.

The attainment of the raised position is detected, for example, by means of an end-of-stroke sensor, known in itself and not shown, incorporated in the actuating device 50.

Finally, the actuating device 54 rotates the rotating key 52 by a predetermined angle such that it couples the beta port 19 with the port 18 in a known manner and allows the rapid transfer port to be opened manually from inside the shielded cell.

After inserting radioactive waste into the shielded container 8 from inside the shielded cell through the open rapid transfer port, e.g. using flange gloves connected to the shielded cell, the operator closes the rapid transfer port and provides another command to the control unit, which operates the actuating devices 12, 46, 50 and 54 in a reverse order to return the support frame 10 to the operating step shown in FIGS. 1 to 3. At this point, the support frame 10 can be unloaded from the housing frame 4 and the shielded container 8 can be slipped off and taken to a technical area or laboratory area, where it can be left for as long as necessary for decay.

Although the above-described invention refers in particular to a well-defined embodiment, it is not to be considered as limited to that embodiment, all those variants, modifications or simplifications covered by the appended claims falling within its scope, such as, for example: the housing frame 4 comprises a single guide 7 and the support frame 10 is transversely centred on the single guide 7; the housing frame 4 does not comprise the guides 7 and the support frame 10 slides with the wheels 11 on the ground; and/or the housing frame 4 comprises a single telescopic guide 43 and the shielded shutter 42 is transversely centred on the single telescopic guide 43.

An advantage of the above-described system 1 is to safely allow the transfer of radioactive waste from a shielded cell to a shielded container 8, minimising radiation leakage and operator exposure to radiation, thanks to the shielded cover 21 and shielded shutter 42 which are moved automatically within the housing frame 4, and thanks to the rapid transfer port 18-19 that allows communication between the inside of the shielded cell and the inside of the shielded container 8, avoiding contamination between the external environment and the inner volumes of the shielded cell and shielded container 8.

Another advantage, which follows from the previous one, is that radioactive waste can be discharged from the shielded cell as and when needed, without having to wait for their decay time, thus increasing the productivity of the activities carried out in the shielded cell. Radioactive waste can therefore remain stored in the shielded container 8, which can be immediately transferred to a technical area or laboratory area.

1. A system for the transfer and storing of radioactive waste for a shielded cell comprising a work surface (2) having an discharge duct (3) for allowing discharge of the radioactive waste, the system (1) comprising: a first frame (4), which is attachable to the shielded cell below the work surface (2); a shielded container (8), which is suitable for containing the radioactive waste, extends along a first axis (9) and is provided with a collar (20); a rapid transfer port, which comprises an alpha port (18) fixable to the discharge duct (3) and openable from inside the shielded cell, and a beta port (19) that closes the shielded container (8); a second frame (10), which supports the shielded container (8) through the collar (20) and is movable with respect to the first frame (4) along a direction (6) transversal to the first axis (9) to and from an alignment position, wherein the shielded container (8) is coaxial to the discharge duct (3); a shielded cover (21), which is mounted on the collar (20) in a movable manner between a first position, in which the shielded cover (21) covers the beta port (19), and a second position, in which the shielded cover (21) is out of the way to allow the shielded container (8) to be lifted from the collar (20); a shielded shutter (42), which is mounted below the work surface (2) in a movable manner between a third position, in which the shielded shutter (42) covers the discharge duct (3), and a fourth position, in which the shielded shutter (42) is out of the way in relation to the discharge duct (3); a lifter (49) for moving the shielded container (8) parallel to the first axis (9) to and from a raised position, in which the beta port (19) rests against the alpha port (18) and which is reachable when the second frame (10) is in the alignment position, the shielded cover (21) is in the second position and the shielded shutter (42) is in the fourth position; and a rotating key (52), which is mounted on the first frame (4) to rotate coaxially to the discharge duct (3) and is engageable by an outer portion (32) of the shielded container (8) when the latter is in the raised position, to allow, by rotation of a predetermined angle, coupling between beta port (19) and alpha port (18) and opening of the rapid transfer port.

2. The system according to claim 1, wherein said first frame (4) comprises at least a first guide (7) parallel to the direction (6) and the second frame (10) is suitable to slide along the first guide (7).

3. The system according to claim 1, and comprising kinematic coupling means (37, 44) for movably connecting the shielded cover (21) to the shielded shutter (42) such that a movement of the shielded shutter (42) towards the fourth position produces a movement of the shielded cover (21) towards the second position.

4. The system according to claim 3, wherein said shielded cover (21) is mounted on the collar (20) so as to rotate about a second axis (25) parallel to the first axis (9) and external to the shielded housing (8), the shielded shutter (42) is slidably mounted along at least a second guide (43) fixed to the first frame (4) and said kinematic coupling means (37, 44) comprise a pivot element (37) which is mounted on an upper face (38) of the shielded cover (21) and is parallel to the first axis (9) to act as a crank with respect to the second axis (25), and a third guide (44), which is arranged on a lower face of the shielded shutter (42), is slidably engageable by the pivot element (37) and defines a path comprising at least one turn (59).

5. The system according to claim 1, wherein said rotary key (52) comprises a first annular element (53), which is arranged within said discharge duct (3) and has an inner face shaped so as to achieve a shape coupling with the outer portion (32) of the shielded container (8); the system (1) comprising an actuating device (54), which comprises a toothed wheel (55) integral with the first annular element (53), a rack (56) coupled with the toothed wheel and a linear actuator (57) for moving the rack.

6. The system according to claim 5, wherein said second frame (10) comprises a support portion (28) for the collar (20) and the latter comprises a second annular element (33) having an inner face equal to that of the first annular element (53) for being engaged with shape coupling by the outer portion (32) of the shielded container (8); the system (1) comprising centring means (34, 35) for positioning the collar (20) on the support portion (28) such that the beta port (19) is positioned according to a predetermined angular displacement around the first axis (9) with respect to the angular position of the alpha port (18).

7. The system according to claim 1, wherein said collar (20) comprises an inner shoulder (31) and said shielded container (8) comprises an annular protrusion (32) adapted to rest on the shoulder (21).

8. The system according to claim 1, wherein said collar (20) comprises a shielded cylindrical portion (36) arranged around the beta port (19) when the shielded container (8) is supported by the second frame (10).

9. The system according to claim 1, and comprising a first actuating device (12) associated with the second frame (10), a second actuating device (46) associated with the shielded shutter (42), a third actuating device (50) associated with the lifter (49), a fourth actuating device (54) associated with the rotary key (52) and a control unit configured to control, in the following order, the first actuating device (12) to advance the second frame (10) to the alignment position, the second actuating device (46) to move the shielded shutter (42) to the fourth position, the third actuating device (5) to raise the container to the raised position, and the fourth actuating device (54) to rotate the rotating key (52) to turn the shielded container (8) by said predefined angle.

10. A shielded cell, for example an isolator for the production of radio-pharmaceuticals, comprising a work surface (2), which has a discharge duct (3) for allowing discharge of radioactive waste from within the shielded cell, and a system (1) for the transfer and storing of radioactive waste according to claim 1.
